(19) United States
(12) Patent Application Publication
(10) Pub. No.: US 2009/0015963 A1
(43) Pub. Date: Jan. 15, 2009

(54) DUAL-DECK CASSETTE PLAYER HAVING AN INTEGRATED DIGITAL COMPUTER SERIAL PORT

(75) Inventor: Richard Seymour, Oxon (GB)

Correspondence Address: BARLOW, JOSEPHS & HOLMES, LTD., 101 DYER STREET, 5TH FLOOR, PROVIDENCE, RI, 02903, US

(73) Assignee: NUMARK INDUSTRIES, LLC, Cumberland, RI (US)

(21) Appl. No.: 12/171,492

(22) Filed: Jul. 11, 2008

Related U.S. Application Data
(60) Provisional application No. 60/949,535, filed on Jul. 13, 2007.

(51) Int. Cl. G11B 15/68

(52) U.S. Cl. 360/90

(57) ABSTRACT

An audio cassette tape player with a computer serial port is disclosed. The player includes a housing having a front panel and a rear panel. An analog output port, analog input port and computer serial port are located on the rear panel. An analog input port located on the rear panel. A first audio cassette deck having an output is located on the front panel. Adjacent thereto, a second audio cassette deck having an output and an input is also located on the front panel. The output of the first deck is electrically connected to the input of the second deck, the analog output port and the computer serial port. The output of the second deck is electrically connected to the analog output port and the computer serial port. Finally, the input port of the second deck is electrically connected to the computer serial port.

### CROSS-REFERENCE TO RELATED APPLICATIONS

The present invention claims priority to earlier filed U.S. Provisional Patent Application Ser. No. 60/949,535, filed on Jul. 13, 2007, the entire contents of which are incorporated herein by reference.

### BACKGROUND OF THE INVENTION

1. Field of the Invention

The present application is related generally to consumer audio electronics and more specifically to a dual cassette tape deck player and recorder that includes a computer serial port to enable archiving of cassette tapes onto a personal computer and transfer of audio onto cassette tape.

2. Background of the Related Art

Many consumers individually still own tens to hundreds of audio cassette tapes. However, cassette audio tapes have been rendered virtually obsolete since the introduction of the compact disc. The advent of portable digital media players that may be synchronized with a music library stored on a personal computer has revolutionized the music industry has further accelerated the decline of the audio cassette tape. Accordingly, it is desirable to transfer music stored on audio cassette tapes onto a personal computer for archival purposes and also to enable this music to be played on portable digital media players.

There are two methods of connecting a cassette tape player to a personal computer in order to transfer or archive the music. The first method is accomplished by using an RCA to ⅛″ stereo adapter. Using the adapter, the RCA outputs on the cassette tape player are connected directly to the microphone port on the sound card of the personal computer. However, this method suffers from the disadvantage of extremely poor sound quality usually due to an unacceptable level of noise in the recording. Poor sound quality is often due to poor quality onboard sound cards.

Alternatively, the consumer can purchase a higher quality sound card or an auxiliary audio interface having USB and/or IEEE 1394 interface. If the consumer uses an auxiliary audio interface, he or she would also need to purchase an appropriate matching RCA adapter to suit. In either case, both options involve added complexity and cost, which is often undesirable.

Accordingly, there is a perceived need for a low cost, and easy to use method of transferring cassette tape deck audio output to a personal computer. Additionally, there is a perceived need to enable such a transfer that preserves the quality of the original audio cassette tape recording without undue degradation.

Even though audio cassette tape technology is falling into disuse, many consumers still frequently use audio cassette tape players. For instance, many consumers still have audio cassette tape decks in their cars rather than a compact disk player. However, because recording studios have diverted their resources into compact disk and other new technologies, consumers often find it difficult to find recent recordings in audio cassette format. Accordingly, there is a perceived need in the consumer market for a device to be able to transfer audio files stored on a personal computer to an audio cassette tape useable in audio cassette tape players.

### SUMMARY OF THE INVENTION

The present invention solves the problems of the prior art by providing a dual-deck audio cassette player with an integrated computer serial port to facilitate transfer of audio stored on an audio cassette tape to a personal computer. In particular, the player includes a housing having a front panel and a rear panel. An analog output port, analog input port and computer serial port are located on the rear panel. An analog input port located on the rear panel. A first audio cassette deck having an output is located on the front panel. Adjacent thereto, a second audio cassette deck having an output and an input is also located on the front panel. The output of the first deck is electrically connected to the input of the second deck, the analog output port and the computer serial port. The output of the second deck is electrically connected to the analog output port and the computer serial port. Finally, the input port of the second deck is electrically connected to the computer serial port.

Accordingly, among the objects of the present invention is the provision for a dual-deck cassette tape player that includes a digital computer serial port to permit transfer the transfer and conversion of analog audio into digital format for use on a personal computer.

Another object of the present invention is the provision to transfer digital audio and conversion thereof to analog format to an audio cassette tape player.

### BRIEF DESCRIPTION OF THE DRAWINGS

These and other features, aspects, and advantages of the present invention will become better understood with reference to the following description, accompanying drawings and claims where:

FIG. 1 is a perspective view of the cassette player of the present invention;

FIG. 2 is a front view of the cassette player of the present invention;

FIG. 2 is a rear view of the cassette player of the present invention; and

FIG. 3 is a flow diagram of the operation of the cassette player of the present invention.

### DETAILED DESCRIPTION OF THE PREFERRED EMBODIMENT

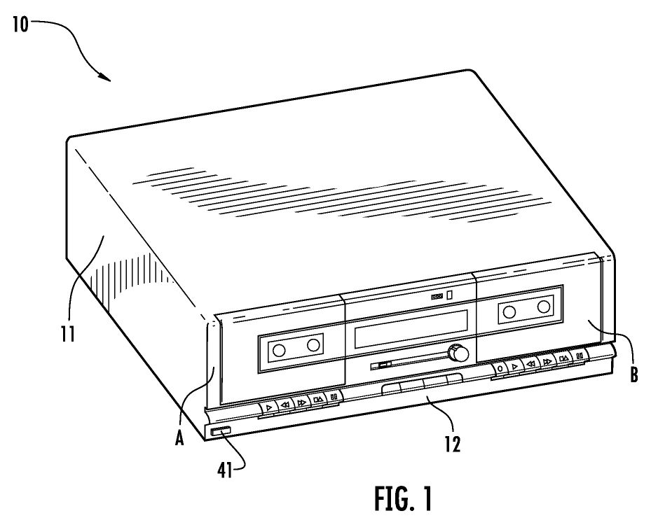

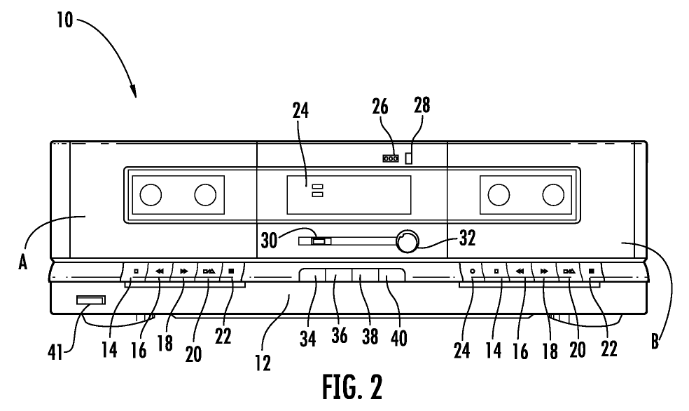

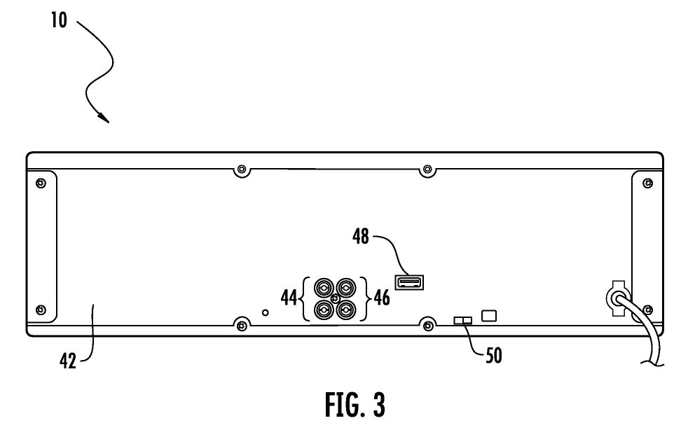

Referring to FIGS. 1-3, the cassette player of the present invention is show generally at 10. The cassette player includes a housing 11 having a front panel 12. The front panel 12 is divided into two decks, Deck A and Deck B. Each deck is configured to play an audio cassette tape, and includes buttons to play 14, rewind 16, fast forward 18, stop and eject 20, and pause 22 an audio cassette tape (not shown). In addition to these functions, deck B also includes a record button 24 to facilitate dubbing of an audio cassette tape in Deck A to an audio cassette tape in Deck B.

Located between the two decks on the front panel 12 are a level meter 24 and several other controls. A counter 26 is included for deck B, which also includes a reset button 28. The counter 26 is useful when dubbing or recording on deck B. A button 30 to activate the dynamic noise reduction function is also included. Additionally a record level knob 32 is included to control the volume of the audio recorded on deck B. A selector switch 34 is also included to allow the decks to play Metal and CrO₂ audio cassette tapes. Another selector switch 36 is included to enable deck B to record to Metal and CrO₂ audio cassette tapes. A selector switch 38 is included to toggle dubbing between deck A and deck B on and off. Another selector switch 40 is included to toggle between normal and high-speed dubbing between deck A and deck B. A power switch 41 is also provided to turn the cassette player 10 on and off.

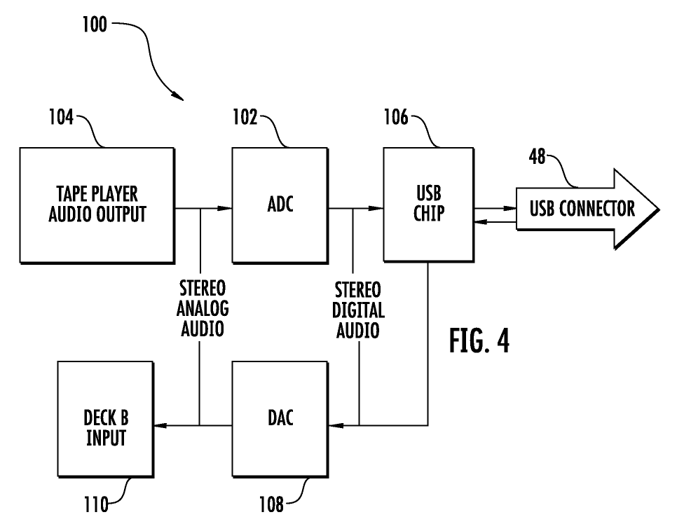

The housing 11 also includes a rear panel 42, best seen in FIG. 3. On the rear panel 42 are a pair of stereo analog inputs 44, such as RCA jacks, and a pair of stereo analog outputs 46, such as RCA jacks. The analog inputs 44 allow recording on Deck B from an outside source. The analog outputs 46 are connected to both decks with Deck A having priority over Deck B. Also on the rear panel 42 is a computer serial port 48, which is preferably a USB port. However, an IEEE 1394 port may also be used. A gain adjustment control 50 is also provided to allow the output signal of the decks to be adjusted.

Referring now to FIG. 4, a conceptual diagram of the interconnection between the decks and the computer serial port is shown generally at 100. In particular, an analog-to-digital converter 102 is spliced into the output 104 of the decks A and B. The analog-to-digital converter 102 is connected to a computer serial port controller 106, which is connected to the computer serial port 48. Preferably, a USB controller is used. However, an IEEE 1394 controller may also be used.

A digital-to-analog converter 108 is also included and connected to the computer serial port controller 106 and the input 110 of Deck B, thus permitting the serial port 48 to function as an audio input like the analog inputs 44. In this manner, the consumer can record an audio signal from the serial port 48 onto an audio cassette tape located in Deck B.

Therefore, it can be seen that the present invention provides a unique solution to the problems of the prior art. The cassette player can be connected to a serial port on a personal computer and audio cassette tapes may be archived on the personal computer in a variety of formats, such as the popular MP3 format. Moreover, music stored on personal computers can also be dubbed onto an audio cassette tape, allowing the consumer to create their own mix tapes for audio cassette players that they still use and where compact disk players are unavailable.

It would be appreciated by those skilled in the art that various changes and modifications can be made to the illustrated embodiments without departing from the spirit of the present invention. All such modifications and changes are intended to be within the scope of the present invention except as limited by the appended claims.

What is claimed is:

1. An audio cassette tape player, comprising:
a housing having a front panel and a rear panel;
an analog output port mounted on the rear panel;
an analog input port mounted on the rear panel;
a computer serial port mounted on the rear panel;
a first audio cassette deck having an output, said first audio cassette deck mounted within the housing and accessible on the front panel;
a second audio cassette deck having an output and an input, said second audio cassette deck mounted within the housing and accessible on the front panel;
said output of the first audio cassette deck electrically connected to the input of the second audio cassette deck, the analog output port and the computer serial port;
said output of the second audio cassette deck electrically connected to the analog output port and the computer serial port; and
said input port of the second audio cassette deck electrically connected to the computer serial port.

2. The apparatus of claim 1, wherein said computer serial port is a USB port.

3. The apparatus of claim 1, wherein said computer serial port is an IEEE 1394 port.

4. The apparatus of claim 1, wherein the analog output is a pair of RCA jacks.

5. The apparatus of claim 1, wherein the analog input is a pair of RCA jacks.

6. An audio cassette tape player, comprising:
a housing having a front panel and a rear panel;
a first audio cassette deck mounted within the housing and accessible on the front panel, said first audio cassette deck having an output;
a second audio cassette deck mounted within the housing and accessible on the front panel, said second audio cassette deck having an output and an input;
an analog-to-digital converter circuit having an input and an output, said input of said analog-to-digital converter circuit electrically connected to said output of said first audio cassette deck and said output of said second audio cassette deck;
a serial port controller having a input and a output, said input of said serial port controller electrically connected to said output of said analog-to-digital converter circuit; and
a computer serial port electrically connected to said output of said serial port controller, said computer serial port located on said rear panel.

7. The apparatus of claim 6, wherein said computer serial port is a USB port.

8. The apparatus of claim 6, wherein said computer serial port is an IEEE 1394 port.

9. The apparatus of claim 6, further comprising:
a digital-to-analog converter circuit having an input and an output, said output of said digital-to-analog converter circuit electrically connected to said input of said second audio cassette deck; and
said input of said serial port controller electrically connected to said input of said digital-to-analog converter circuit.

10. The apparatus of claim 9, wherein said computer serial port is a USB port.

11. The apparatus of claim 9, wherein said computer serial port is an IEEE 1394 port.

12. The apparatus if claim 6, further comprising an analog output port electrically connected to said output of said first audio cassette deck and said output of said second audio cassette deck.

13. The apparatus of claim 12, wherein said analog output port is a pair of RCA jacks.

14. The apparatus of claim 6, further comprising an analog input port electrically connected to said input of said second audio cassette deck.

15. The apparatus of claim 14, wherein said analog input port is a pair of RCA jacks.
